(19) United States
(12) Patent Application Publication
(10) Pub. No.: US 2013/0121423 A1
(43) Pub. Date: May 16, 2013

(54) VIDEO DATA ENCODING AND DECODING

(71) Applicant: Sony Corporation, Tokyo (JP)

(72) Inventors: James Alexander GAMEI, Kingston-upon-Thames (GB); Nicholas Ian Saunders, Basingstoke (GB); Karl James Sharman, Eastleigh (GB); Paul James Silcock, Highworth (GB)

(73) Assignee: Sony Corporation, Tokyo (JP)

(21) Appl. No.: 13/669,771

(22) Filed: Nov. 6, 2012

(30) Foreign Application Priority Data
Nov. 7, 2011 (GB) 1119177.2

(51) Int. Cl. H04N 7/26

(52) U.S. Cl. CPC H04N 19/00
USPC 375/240.26

(57) ABSTRACT

Video data encoding apparatus in which arrays of video data are reordered for entropy encoding includes a frequency domain converter for generating a frequency domain representation of data derived from an input video signal, the frequency domain representation including an array of plural frequency domain coefficients in respect of each image area. The apparatus includes a selector for selecting a reordering pattern from a set of two or more candidate reordering patterns, for use in reordering the array of frequency domain coefficients. The apparatus includes a data scanner for changing the order of the frequency domain coefficients according to the selected reordering pattern so as to generate reordered coefficients. The apparatus further includes an entropy encoder for entropy-encoding the reordered coefficients.

### CROSS REFERENCE TO RELATED APPLICATION

The present application claims the benefit of the earlier filing date of GB1119177.2 filed in the United Kingdom Intellectual Property Office on 7 Nov. 2011, the entire content of which application is incorporated herein by reference.

### FIELD OF THE INVENTION

This invention relates to video data encoding and decoding.

### DESCRIPTION OF THE RELATED ART

The “background” description provided herein is for the purpose of generally presenting the context of the disclosure. Work of the presently named inventors, to the extent it is described in this background section, as well as aspects of the description which may not otherwise qualify as prior art at the time of filing, are neither expressly or impliedly admitted as prior art against the present invention.

There are several video data compression and decompression systems (as examples of encoding and decoding systems) which involve transforming video data into a frequency domain representation, quantising the frequency domain coefficients and then applying some form of entropy encoding to the quantised coefficients.

Entropy, in the present context, can be considered as representing the information content of a data symbol or series of symbols. The aim of entropy encoding is to encode a series of data symbols in a lossless manner using (ideally) the smallest number of encoded data bits which are necessary to represent the information content of that series of data symbols. In practice, entropy encoding is used to encode the quantised coefficients such that the encoded data is smaller (in terms of its number of bits) than the data size of the original quantised coefficients. A more efficient entropy encoding process gives a smaller output data size for the same input data size.

An important part of the entropy encoding process used in video data compression relates to the order in which the quantised coefficients are presented for encoding.

Typically, a data scanning or reordering process is applied to the quantised coefficients. The purpose of the scanning process is to reorder the quantised frequency-transformed data so as to gather as many as possible of the non-zero quantised transformed coefficients together, and of course therefore to gather as many as possible of the zero-valued coefficients together. These features can allow so-called run-length coding or similar techniques (which encode runs or successive sequences of zeros by a small number of data bits defining the length of the run) to be applied efficiently. So, the scanning process involves selecting coefficients from the quantised transformed data, and in particular from a block of coefficients corresponding to a block of image data which has been transformed and quantised, according to a “scanning order” so that (a) all of the coefficients are selected once as part of the scan, and (b) the scan tends to provide the desired reordering.

In practical terms, the output of the frequency domain transformation stage typically comprises a set of frequency domain coefficients which vary according to the horizontal and vertical spatial frequencies which they represent in the original image block. There is generally a so-called “DC” coefficient which represents the average (DC) value of the samples in the original image block, together with a succession of coefficients representing respective permutations of low or high horizontal and vertical spatial frequency ranges.

The way in which these coefficients are ordered for transmission to the data scanning process is of course arbitrary, but for convenience the coefficients are often considered to form a data array with the DC coefficient in a top-left corner of the array, increasing horizontal spatial frequency represented in a left-to-right direction in the array and increasing vertical spatial frequency represented in a top-to-bottom direction in the array. Under this representation, a data scanning process which has been found to provide useful results is a so-called zigzag scan, which starts with the DC coefficient and then proceeds through the remaining coefficients, one by one, in a zigzag fashion. An example of a zigzag scan is illustrated schematically in FIG. 16 of the accompanying drawings. The scanning pattern would mean that the first two coefficients scanned after the DC coefficient would be those representing: (a) zero vertical spatial frequency and the lowest horizontal spatial frequency range; and (b) zero horizontal spatial frequency and the lowest vertical spatial frequency range, respectively. After that, the scan proceeds so that successive diagonals (in a lower-left to upper-right direction) of the array of coefficients are scanned, one coefficient at a time.

The zigzag scan is considered advantageous because, for many normal types of image, and in particular images which have been captured from real scenes, most of the information content tends to lie in the DC and low frequency coefficients. It is often the case that many or all of the higher frequency coefficients are zero. This is particularly the case in systems such as the proposed “High Efficiency Video Coding” (HEVC) system in which residual image data (that is to say, data representing the difference between an actual image and a predicted version of that image) is encoded. So, by scanning the DC and lower frequency coefficients first, the non-zero values can tend to be gathered together and the zero values can also tend to be gathered together. As mentioned above, this can lead to a more efficient entropy encoding process.

### SUMMARY

This invention provides video data encoding apparatus in which arrays of video data are reordered for entropy encoding, the apparatus comprising:

a frequency domain converter for generating a frequency domain representation of data derived from an input video signal, the frequency domain representation comprising an array of plural frequency domain coefficients in respect of each image area;

a selector for selecting a reordering pattern from a set of two or more candidate reordering patterns, for use in reordering the array of frequency domain coefficients;

a data scanner for changing the order of the frequency domain coefficients according to the selected reordering pattern so as to generate reordered coefficients; and

an entropy encoder for entropy-encoding the reordered coefficients;

in which the candidate reordering patterns include at least one reordering pattern selected from the list consisting of:

a first reordering pattern arranged to reorder the frequency domain data so that the reordered data comprises successive subsets of the frequency domain data, each subset comprising data representative of a constant spatial frequency in one dimension, the one dimension being different from subset to subset;

a second reordering pattern arranged to reorder the frequency domain data so that data indicative of one or more sets of a constant horizontal spatial frequency or a constant vertical spatial frequency respectively are arranged to precede remaining data of the frequency domain data, the remaining frequency domain data being ordered according to successive subsets, each subset being selected so that the sum of a horizontal spatial frequency component and a vertical spatial frequency component is generally constant for coefficients within a subset; and

a third reordering pattern arranged to reorder the frequency domain data according to successive subsets alternating between a constant and increasing horizontal spatial frequency and a constant and increasing vertical spatial frequency.

The invention recognises that depending on properties of the image data to be compressed or other aspects of the compression process, an improved efficiency (which is to say, a lower number of output data bits) may be obtained by varying the scanning (reordering) pattern used to scan the data for entropy encoding.

Further respective aspects and features of the invention are defined in the appended claims.

It is to be understood that both the foregoing general description of the invention and the following detailed description are exemplary, but not restrictive of, the invention.

### BRIEF DESCRIPTION OF THE DRAWINGS

A more complete appreciation of the disclosure and many of the attendant advantages thereof will be readily obtained as the same becomes better understood by reference to the following detailed description of embodiments of the invention, when considered in connection with the accompanying drawings, wherein:

FIG. 1 schematically illustrates an audio/video (A/V) data transmission and reception system using video data compression and decompression;

FIG. 2 schematically illustrates a video display system using video data decompression;

FIG. 3 schematically illustrates an audio/video storage system using video data compression and decompression;

FIG. 4 schematically illustrates a video camera using video data compression;

FIG. 5 provides a schematic overview of a video data compression and decompression apparatus;

FIG. 6 schematically illustrates the generation of predicted images;

FIG. 7 schematically illustrates a largest coding unit (LCU);

FIG. 8 schematically illustrates a set of four coding units (CU);

FIGS. 9 and 10 schematically illustrate the coding units of FIG. 8 sub-divided into smaller coding units;

FIG. 11 schematically illustrates an array of prediction units (PU);

FIG. 12 schematically illustrates an array of transform units (TU);

FIG. 13 schematically illustrates a partially-encoded image;

FIG. 14 schematically illustrates a set of possible prediction directions;

FIG. 15 schematically illustrates a set of prediction modes;

FIG. 16 schematically illustrates a zigzag scan;

FIG. 17 schematically illustrates a CABAC entropy encoder;

FIG. 18 schematically illustrates a CAVLC entropy encoding process;

FIG. 19 schematically illustrates a concave scan order, vertical first;

FIG. 20 schematically illustrates a concave scan order, horizontal first;

FIG. 21 schematically illustrates a horizontal hybrid zig scan order;

FIG. 22 schematically illustrates a vertical hybrid zig scan order;

FIG. 23 schematically illustrates a rectangular scan order;

FIG. 24 schematically illustrates mode-dependent scanning in respect of 4×4 sub-blocks;

FIG. 25 schematically illustrates a scan to detect an end of block;

FIG. 26 schematically illustrates an enhanced scan up to the end of block;

FIG. 27 schematically illustrates a scan in the case that the end of block is in the top row of coefficients;

FIGS. 28A and 28B schematically illustrate a throughput-friendly zig scan;

FIGS. 29A and 29B schematically illustrate selections of scan orders in dependence upon the intra-mode prediction direction associated with a block;

FIG. 30 schematically illustrates a data field defining the scan order associated with a block;

FIG. 31 schematically illustrates an intra-mode prediction direction detector; and

FIG. 32 schematically illustrates a motion vector detector;

FIG. 33 schematically illustrates a scan order selection arrangement at an encoder; and

FIG. 34 schematically illustrates a scan order selection arrangement at a decoder.

### DESCRIPTION OF THE EMBODIMENTS

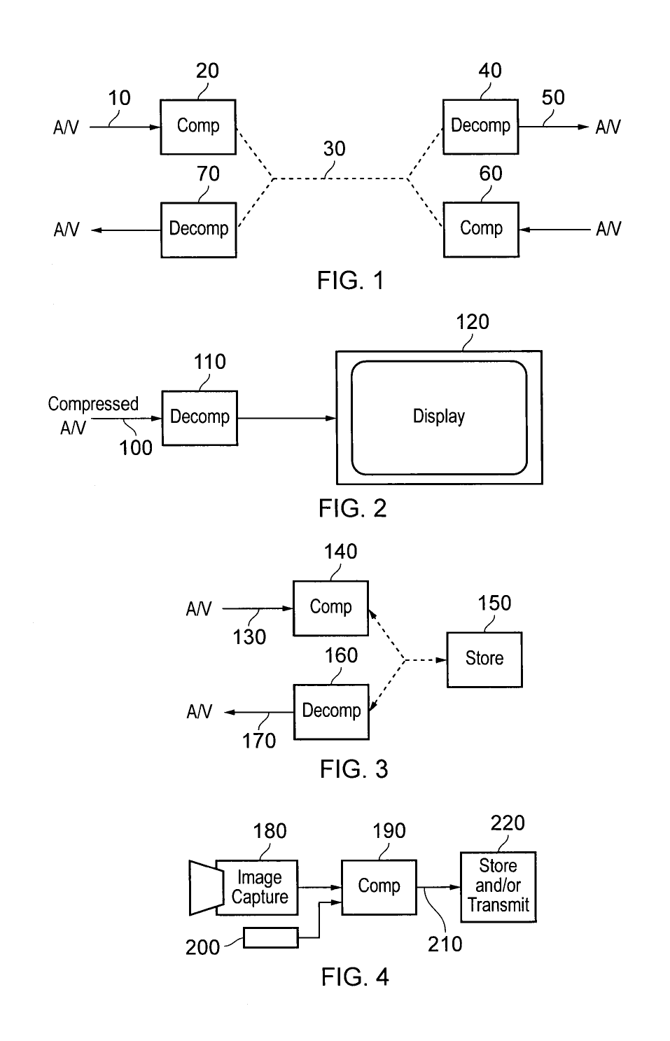

Referring now to the drawings, FIGS. 1-4 are provided to give schematic illustrations of apparatus or systems making use of the compression and/or decompression apparatus to be described below in connection with embodiments of the invention.

All of the data compression and/or decompression apparatus is to be described below may be implemented in hardware, in software running on a general-purpose data processing apparatus such as a general-purpose computer, as programmable hardware such as an application specific integrated circuit (ASIC) or field programmable gate array (FPGA) or as combinations of these. In cases where the embodiments are implemented by software and/or firmware, it will be appreciated that such software and/or firmware, and non-transitory machine-readable data storage media by which such software and/or firmware are stored or otherwise provided, are considered as embodiments of the present invention.

FIG. 1 schematically illustrates an audio/video data transmission and reception system using video data compression and decompression.

An input audio/video signal 10 is supplied to a video data compression apparatus 20 which compresses at least the video component of the audio/video signal 10 for transmission along a transmission route 30 such as a cable, an optical fibre, a wireless link or the like. The compressed signal is processed by a decompression apparatus 40 to provide an output audio/video signal 50. For the return path, a compression apparatus 60 compresses an audio/video signal for transmission along the transmission route 30 to a decompression apparatus 70.

The compression apparatus 20 and decompression apparatus 70 can therefore form one node of a transmission link. The decompression apparatus 40 and decompression apparatus 60 can form another node of the transmission link. Of course, in instances where the transmission link is uni-directional, only one of the nodes would require a compression apparatus and the other node would only require a decompression apparatus.

FIG. 2 schematically illustrates a video display system using video data decompression. In particular, a compressed audio/video signal 100 is processed by a decompression apparatus 110 to provide a decompressed signal which can be displayed on a display 120. The decompression apparatus 110 could be implemented as an integral part of the display 120, for example being provided within the same casing as the display device. Alternatively, the decompression apparatus 110 might be provided as (for example) a so-called set top box (STB), noting that the expression “set-top” does not imply a requirement for the box to be sited in any particular orientation or position with respect to the display 120; it is simply a term used in the art to indicate a device which is connectable to a display as a peripheral device.

FIG. 3 schematically illustrates an audio/video storage system using video data compression and decompression. An input audio/video signal 130 is supplied to a compression apparatus 140 which generates a compressed signal for storing by a store device 150 such as a magnetic disk device, an optical disk device, a magnetic tape device, a solid state storage device such as a semiconductor memory or other storage device. For replay, compressed data is read from the store device 150 and passed to a decompression apparatus 160 for decompression to provide an output audio/video signal 170.

It will be appreciated that the compressed or encoded signal, and a storage medium storing that signal, are considered as embodiments of the present invention.

FIG. 4 schematically illustrates a video camera using video data compression. In FIG. 4, and image capture device 180, such as a charge coupled device (CCD) image sensor and associated control and read-out electronics, generates a video signal which is passed to a compression apparatus 190. A microphone (or plural microphones) 200 generates an audio signal to be passed to the compression apparatus 190. The compression apparatus 190 generates a compressed audio/video signal 210 to be stored and/or transmitted (shown generically as a schematic stage 220).

The techniques to be described below relate primarily to video data compression. It will be appreciated that many existing techniques may be used for audio data compression in conjunction with the video data compression techniques which will be described, to generate a compressed audio/video signal. Accordingly, a separate discussion of audio data compression will not be provided. It will also be appreciated that the data rate associated with video data, in particular broadcast quality video data, is generally very much higher than the data rate associated with audio data (whether compressed or uncompressed). It will therefore be appreciated that uncompressed audio data could accompany compressed video data to form a compressed audio/video signal. It will further be appreciated that although the present examples (shown in FIGS. 1-4) relate to audio/video data, the techniques to be described below can find use in a system which simply deals with (that is to say, compresses, decompresses, stores, displays and/or transmits) video data. That is to say, the embodiments can apply to video data compression without necessarily having any associated audio data handling at all.

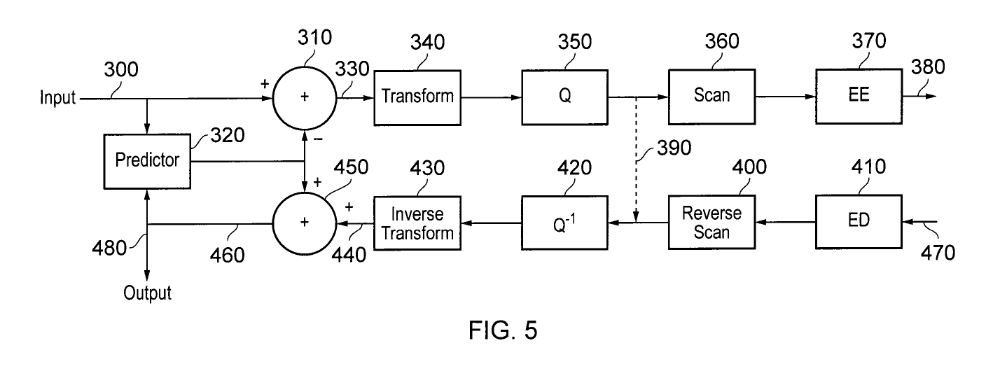

FIG. 5 provides a schematic overview of a video data compression and decompression apparatus.

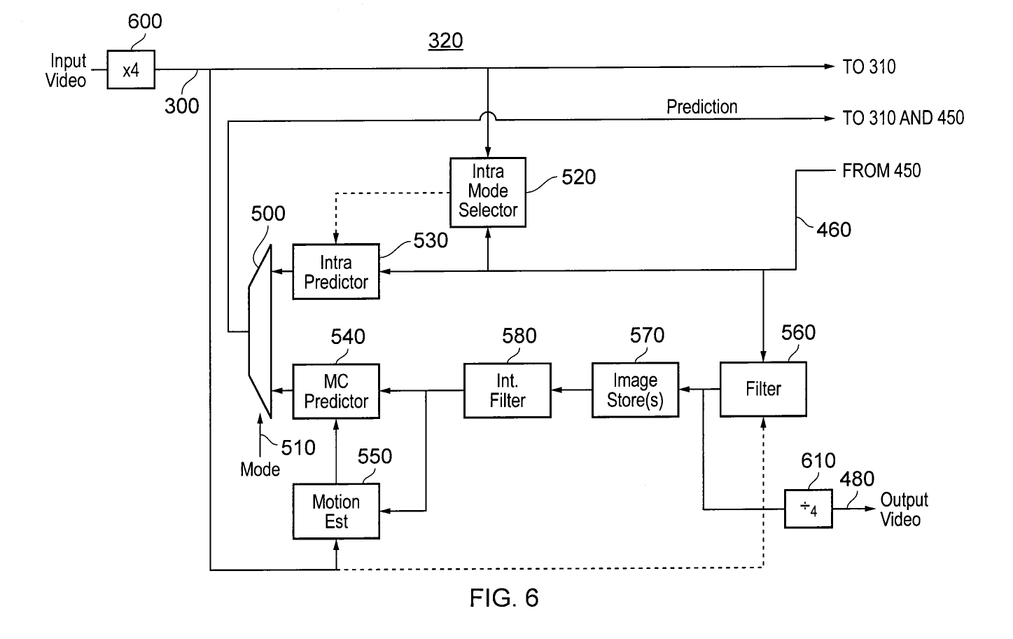

Successive images of an input video signal 300 are supplied to an adder 310 and to an image predictor 320. The image predictor 320 will be described below in more detail with reference to FIG. 6. The adder 310 in fact performs a subtraction (negative addition) operation, in that it receives the input video signal 300 on a “+” input and the output of the image predictor 320 on a “−” input, so that the predicted image is subtracted from the input image. The result is to generate a so-called residual image signal 330 representing the difference between the actual and projected images.

One reason why a residual image signal is generated is as follows. The data coding techniques to be described, that is to say the techniques which will be applied to the residual image signal, tends to work more efficiently when there is less “energy” in the image to be encoded. Here, the term “efficiently” refers to the generation of a small amount of encoded data; for a particular image quality level, it is desirable (and considered “efficient”) to generate as little data as is practicably possible. The reference to “energy” in the residual image relates to the amount of information contained in the residual image. If the predicted image were to be identical to the real image, the difference between the two (that is to say, the residual image) would contain zero information (zero energy) and would be very easy to encode into a small amount of encoded data. In general, if the prediction process can be made to work reasonably well, the expectation is that the residual image data will contain less information (less energy) than the input image and so will be easier to encode into a small amount of encoded data.

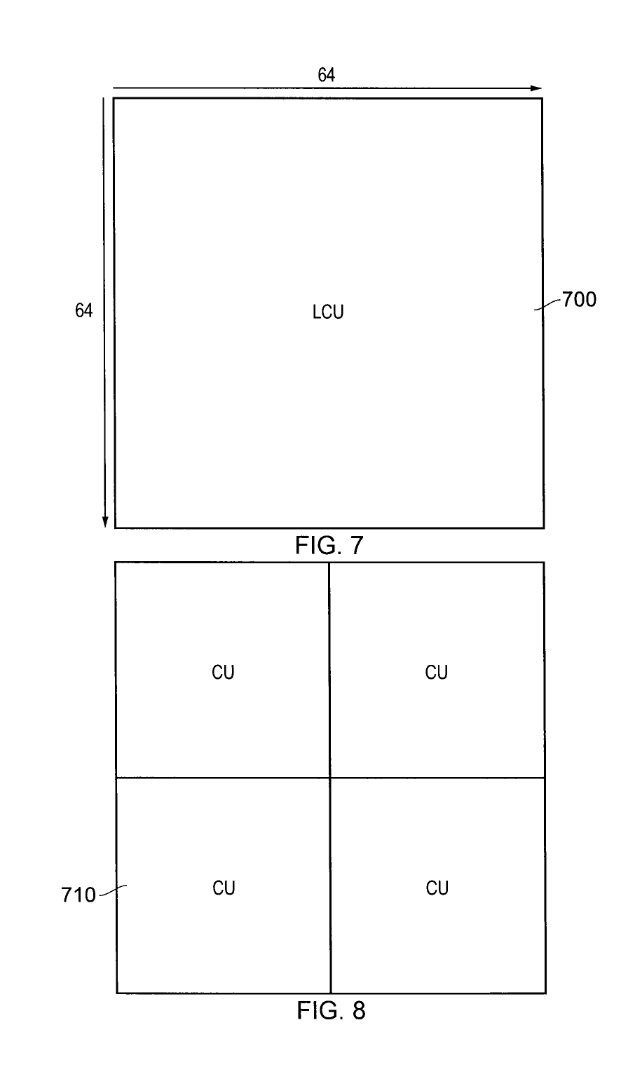

The residual image data 330 is supplied to a transform unit 340 which generates a discrete cosine transform (DCT) representation of the residual image data. The DCT technique itself is well known and will not be described in detail here. There are however aspects of the techniques used in the present apparatus which will be described in more detail below, in particular relating to the selection of different blocks of data to which the DCT operation is applied. These will be discussed with reference to FIGS. 7-12 below.

The output of the transform unit 340, which is to say, a set of DCT coefficients for each transformed block of image data, is supplied to a quantiser 350. Various quantisation techniques are known in the field of video data compression, ranging from a simple multiplication by a quantisation scaling factor through to the application of complicated lookup tables under the control of a quantisation parameter. The general aim is twofold. Firstly, the quantisation process reduces the number of possible values of the transformed data. Secondly, the quantisation process can increase the likelihood that values of the transformed data are zero. Both of these can make the entropy encoding process, to be described below, work more efficiently in generating small amounts of compressed video data.

A data scanning process is applied by a scan unit 360. The purpose of the scanning process is to reorder the quantised transformed data so as to gather as many as possible of the non-zero quantised transformed coefficients together, and of course therefore to gather as many as possible of the zero-valued coefficients together. These features can allow so-called run-length coding or similar techniques to be applied efficiently. So, the scanning process involves selecting coefficients from the quantised transformed data, and in particular from a block of coefficients corresponding to a block of image data which has been transformed and quantised, according to a “scanning order” so that (a) all of the coefficients are selected once as part of the scan, and (b) the scan tends to provide the desired reordering. Techniques for selecting a scanning order will be described below. One example scanning order which can tend to give useful results is a so-called zigzag scanning order.

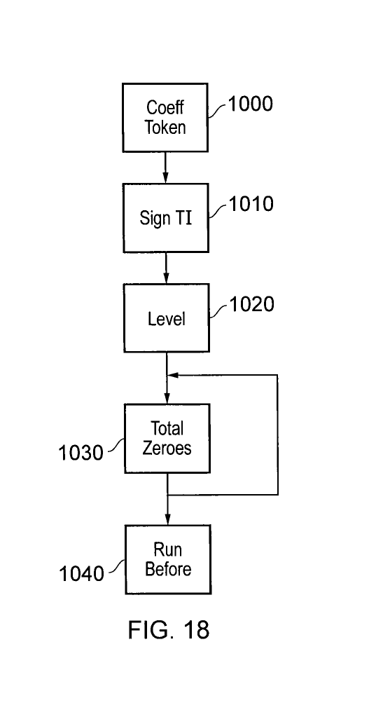

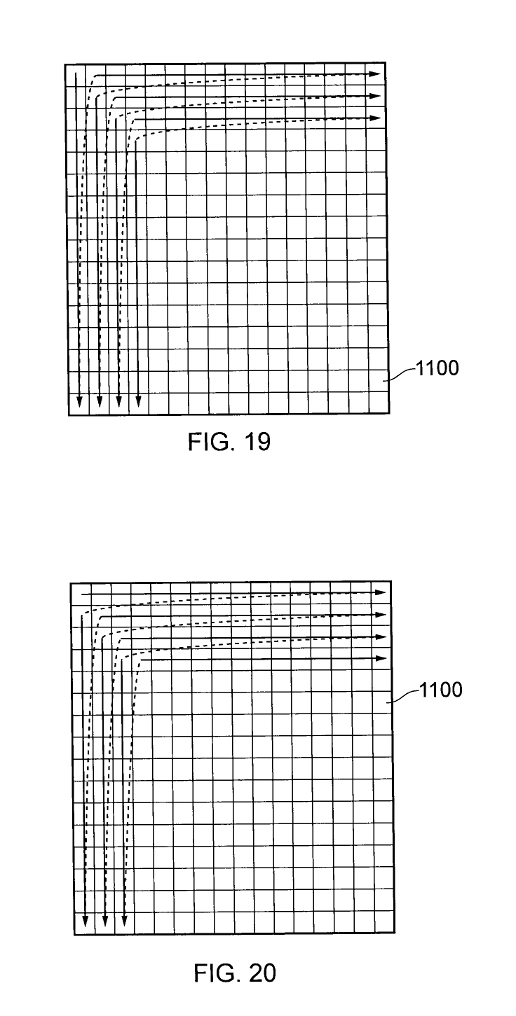

The scanned coefficients are then passed to an entropy encoder (EE) 370. Again, various types of entropy encoding may be used. Two examples which will be described below are variants of the so-called CABAC (Context Adaptive Binary Arithmetic Coding) system and variants of the so-called CAVLC (Context Adaptive Variable-Length Coding) system. In general terms, CABAC is considered to provide a better efficiency, and in some studies has been shown to provide a 10-20% reduction in the quantity of encoded output data for a comparable image quality compared to CAVLC. However, CAVLC is considered to represent a much lower level of complexity (in terms of its implementation) than CABAC. The CABAC technique will be discussed with reference to FIG. 17 below, and the CAVLC technique will be discussed with reference to FIGS. 18 and 19 below.

Note that the scanning process and the entropy encoding process are shown as separate processes, but in fact can be combined or treated together. That is to say, the reading of data into the entropy encoder can take place in the scan order. Corresponding considerations apply to the respective inverse processes to be described below.

The output of the entropy encoder 370, along with additional data (mentioned above and/or discussed below), for example defining the manner in which the predictor 320 generated the predicted image, provides a compressed output video signal 380.

However, a return path is also provided because the operation of the predictor 320 itself depends upon a decompressed version of the compressed output data.

The reason for this feature is as follows. At the appropriate stage in the decompression process (to be described below) a decompressed version of the residual data is generated. This decompressed residual data has to be added to a predicted image to generate an output image (because the original residual data was the difference between the input image and a predicted image). In order that this process is comparable, as between the compression side and the decompression side, the predicted images generated by the predictor 320 should be the same during the compression process and during the decompression process. Of course, at decompression, the apparatus does not have access to the original input images, but only to the decompressed images. Therefore, at compression, the predictor 320 bases its prediction (at least, for inter-image encoding) on decompressed versions of the compressed images.

The entropy encoding process carried out by the entropy encoder 370 is considered to be “lossless”, which is to say that it can be reversed to arrive at exactly the same data which was first supplied to the entropy encoder 370. So, the return path can be implemented before the entropy encoding stage. Indeed, the scanning process carried out by the scan unit 360 is also considered lossless, but in the present embodiment the return path 390 is from the output of the quantiser 350 to the input of a complimentary inverse quantiser 420.

In general terms, an entropy decoder 410, the reverse scan unit 400, an inverse quantiser 420 and an inverse transform unit 430 provide the respective inverse functions of the entropy encoder 370, the scan unit 360, the quantiser 350 and the transform unit 340. For now, the discussion will continue through the compression process; the process to decompress an input compressed video signal will be discussed separately below.

In the compression process, the scanned coefficients are passed by the return path 390 from the quantiser 350 to the inverse quantiser 420 which carries out the inverse operation of the scan unit 360. An inverse quantisation and inverse transformation process are carried out by the units 420, 430 to generate a compressed-decompressed residual image signal 440.

The image signal 440 is added, at an adder 450, to the output of the predictor 320 to generate a reconstructed output image 460. This forms one input to the image predictor 320, as will be described below.

Turning now to the process applied to a received compressed video signal 470, the signal is supplied to the entropy decoder 410 and from there to the chain of the reverse scan unit 400, the inverse quantiser 420 and the inverse transform unit 430 before being added to the output of the image predictor 320 by the adder 450. In straightforward terms, the output 460 of the adder 450 forms the output decompressed video signal 480. In practice, further filtering may be applied before the signal is output.

FIG. 6 schematically illustrates the generation of predicted images, and in particular the operation of the image predictor 320.

There are two basic modes of prediction: so-called intra-image prediction and so-called inter-image, or motion-compensated (MC), prediction.

Intra-image prediction bases a prediction of the content of a block of the image on data from within the same image. This corresponds to so-called I-frame encoding in other video compression techniques. In contrast to I-frame encoding, where the whole image is intra-encoded, in the present embodiments the choice between intra- and inter- encoding can be made on a block-by-block basis, though in other embodiments of the invention the choice is still made on an image-by-image basis.

Motion-compensated prediction makes use of motion information which attempts to define the source, in another adjacent or nearby image, of image detail to be encoded in the current image. Accordingly, in an ideal example, the contents of a block of image data in the predicted image can be encoded very simply as a reference (a motion vector) pointing to a corresponding block at the same or a slightly different position in an adjacent image.

Returning to FIG. 6, two image prediction arrangements (corresponding to intra- and inter-image prediction) are shown, the results of which are selected by a multiplexer 500 under the control of a mode signal 510 so as to provide blocks of the predicted image for supply to the adders 310 and 450. The choice is made in dependence upon which selection gives the lowest “energy” (which, as discussed above, may be considered as information content requiring encoding), and the choice is signalled to the encoder within the encoded output datastream. Image energy, in this context, can be detected, for example, by carrying out a trial subtraction of an area of the two versions of the predicted image from the input image, squaring each pixel value of the difference image, summing the squared values, and identifying which of the two versions gives rise to the lower mean squared value of the difference image relating to that image area.

The actual prediction, in the intra-encoding system, is made on the basis of image blocks received as part of the signal 460, which is to say, the prediction is based upon encoded-decoded image blocks in order that exactly the same prediction can be made at a decompression apparatus. However, data can be derived from the input video signal 300 by an intra-mode selector 520 to control the operation of the intra-image predictor 530.

For inter-image prediction, a motion compensated (MC) predictor 540 uses motion information such as motion vectors derived by a motion estimator 550 from the input video signal 300. Those motion vectors are applied to a processed version of the reconstructed image 460 by the motion compensated predictor 540 to generate blocks of the inter-image prediction.

The processing applied to the signal 460 will now be described. Firstly, the signal is filtered by a filter unit 560. This involves applying a “deblocking” filter to remove or at least tend to reduce the effects of the block-based processing carried out by the transform unit 340 and subsequent operations. Also, an adaptive loop filter is applied using coefficients derived by processing the reconstructed signal 460 and the input video signal 300. The adaptive loop filter is a type of filter which, using known techniques, applies adaptive filter coefficients to the data to be filtered. That is to say, the filter coefficients can vary in dependence upon various factors. Data defining which filter coefficients to use is included as part of the encoded output datastream.

The filtered output from the filter unit 560 in fact forms the output video signal 480. It is also buffered in one or more image stores 570; the storage of successive images is a requirement of motion compensated prediction processing, and in particular the generation of motion vectors. To save on storage requirements, the stored images in the image stores 570 may be held in a compressed form and then decompressed for use in generating motion vectors. For this particular purpose, any known compression/decompression system may be used. The stored images are passed to an interpolation filter 580 which generates a higher resolution version of the stored images; in this example, intermediate samples (sub-samples) are generated such that the resolution of the interpolated image is output by the interpolation filter 580 is 8 times (in each dimension) that of the images stored in the image stores 570. The interpolated images are passed as an input to the motion estimator 550 and also to the motion compensated predictor 540.

In embodiments of the invention, a further optional stage is provided, which is to multiply the data values of the input video signal by a factor of four using a multiplier 600 (effectively just shifting the data values left by two bits), and to apply a corresponding divide operation (shift right by two bits) at the output of the apparatus using a divider or right-shifter 610. So, the shifting left and shifting right changes the data purely for the internal operation of the apparatus. This measure can provide for higher calculation accuracy within the apparatus, as the effect of any data rounding errors is reduced.

The way in which an image is partitioned for compression processing will now be described. At a basic level, and image to be compressed is considered as an array of blocks of samples. For the purposes of the present discussion, the largest such block under consideration is a so-called largest coding unit (LCU) 700 (FIG. 7), which represents a square array of 64×64 samples. Here, the discussion relates to luminance samples. Depending on the chrominance mode, such as 4:4:4, 4:2:2, 4:2:0 or 4:4:4:4 (GBR plus key data), there will be differing numbers of corresponding chrominance samples corresponding to the luminance block.

Three basic types of blocks will be described: coding units, prediction units and transform units. In general terms, the recursive subdividing of the LCUs allows an input picture to be partitioned in such a way that both the block sizes and the block coding parameters (such as prediction or residual coding modes) can be set according to the specific characteristics of the image to be encoded.

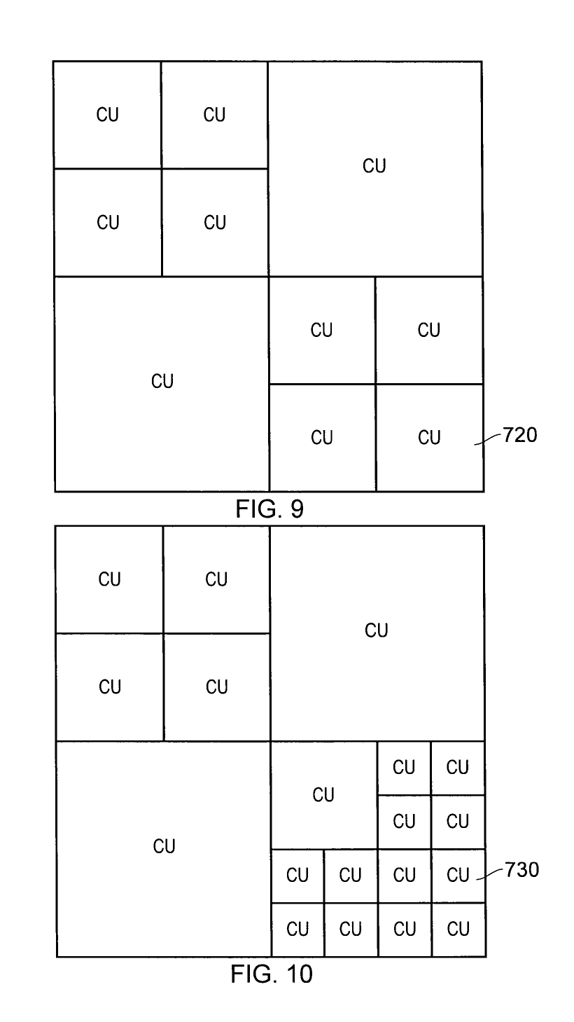

The LCU may be subdivided into so-called coding units (CU). Coding units are always square and have a size between 8×8 samples and the full size of the LCU 700. The coding units can be arranged as a kind of tree structure, so that a first subdivision may take place as shown in FIG. 8, giving coding units 710 of 32×32 samples; subsequent subdivisions may then take place on a selective basis so as to give some coding units 720 of 16×16 samples (FIG. 9) and potentially some coding units 730 of 8×8 samples (FIG. 10). Overall, this process can provide a content-adapting coding tree structure of CU blocks, each of which may be as large as the LCU or as small as 8×8 samples. Encoding of the output video data takes place on the basis of the coding unit structure.

FIG. 11 schematically illustrates an array of prediction units (PU). A prediction unit is a basic unit for carrying information relating to the image prediction processes, or in other words the additional data added to the entropy encoded residual image data to form the output video signal from the apparatus of FIG. 5. In general, prediction units are not restricted to being square in shape. They can take other shapes, in particular rectangular shapes forming half of one of the square coding units, as long as the coding unit is greater than the minimum (8×8) size. The aim is to allow the boundary of adjacent prediction units to match (as closely as possible) the boundary of real objects in the picture, so that different prediction parameters can be applied to different real objects. Each coding unit may contain one or more prediction units.

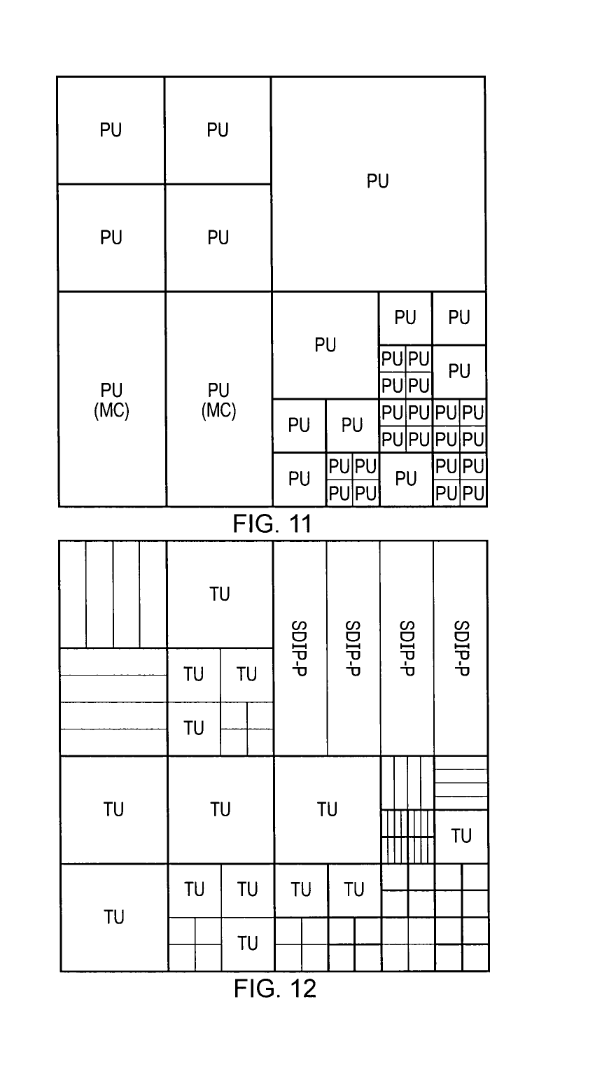

FIG. 12 schematically illustrates an array of transform units (TU). A transform unit is a basic unit of the transform and quantisation process. Transform units are always square and can take a size from 4×4 up to 32×32 samples. Each coding unit can contain one or more transform units. The acronym SDIP-P in FIG. 12 signifies a so-called short distance intra-prediction partition. In this arrangement only one dimensional transforms are used, so a 4×N block is passed through N transforms with input data to the transforms being based upon the previously decoded neighbouring blocks and the previously decoded neighbouring lines within the current SDIP-P.

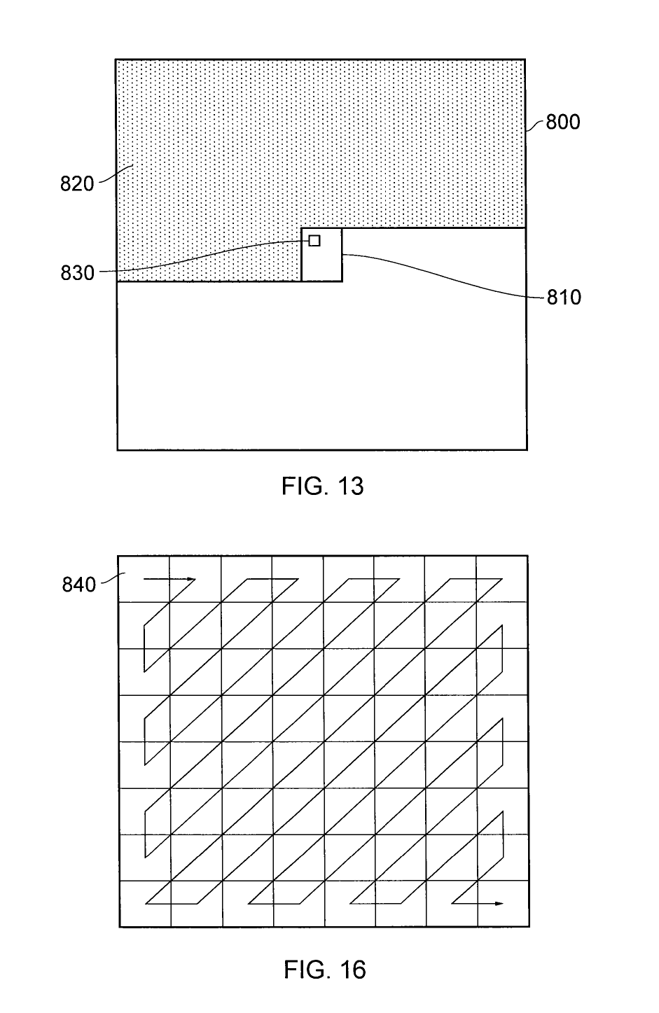

The intra-prediction process will now be discussed. In general terms, intra-prediction involves generating a prediction of a current block (a prediction unit) of samples from previously-encoded and decoded samples in the same image. FIG. 13 schematically illustrates a partially encoded image 800. Here, the image is being encoded from top-left to bottom-right on an LCU basis. An example LCU encoded partway through the handling of the whole image is shown as a block 810. A shaded region 820 above and to the left of the block 810 has already been encoded. The intra-image prediction of the contents of the block 810 can make use of any of the shaded area 820 but cannot make use of the unshaded area below that.

The block 810 represents an LCU; as discussed above, for the purposes of intra-image prediction processing, this may be subdivided into a set of smaller prediction units. An example of a prediction unit 830 is shown within the LCU 810.

The intra-image prediction takes into account samples above and/or to the left of the current LCU 810. Source samples, from which the required samples are predicted, may be located at different positions or directions relative to a current prediction unit within the LCU 810. To decide which direction is appropriate for a current prediction unit, the results of a trial prediction based upon each candidate direction are compared in order to see which candidate direction gives an outcome which is closest to the corresponding block of the input image. The candidate direction giving the closest outcome is selected as the prediction direction for that prediction unit.

The picture may also be encoded on a “slice” basis. In one example, a slice is a horizontally adjacent group of LCUs. But in more general terms, the entire residual image could form a slice, or a slice could be a single LCU, or a slice could be a row of LCUs, and so on. Slices can give some resilience to errors as they are encoded as independent units. The encoder and decoder states are completely reset at a slice boundary. For example, intra-prediction is not carried out across slice boundaries; slice boundaries are treated as image boundaries for this purpose.

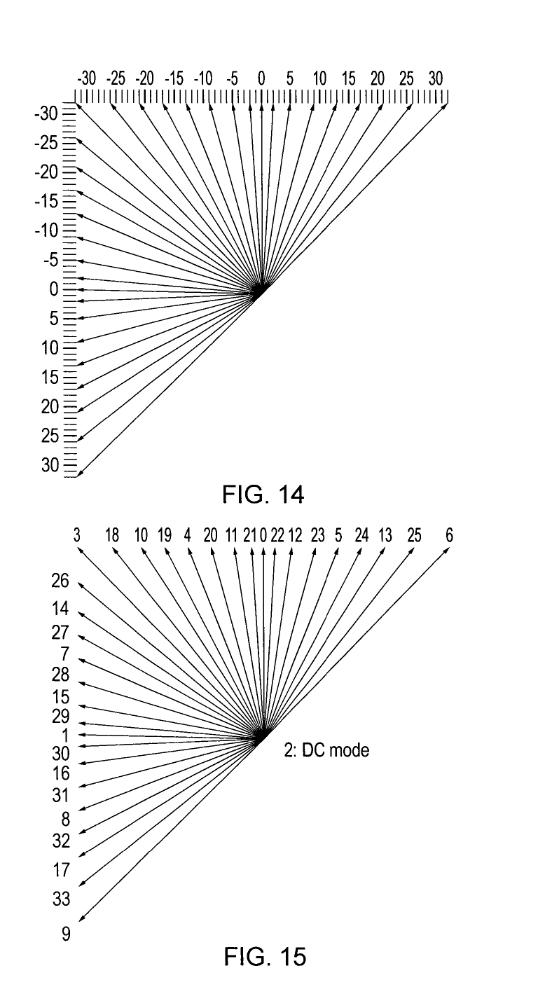

FIG. 14 schematically illustrates a set of possible (candidate) prediction directions. The full set of 34 candidate directions is available to a prediction unit of 8×8, 16×16 or 32×32 samples. The special cases of prediction unit sizes of 4×4 and 64×64 samples have a reduced set of candidate directions available to them (17 candidate directions and 5 candidate directions respectively). The directions are determined by horizontal and vertical displacement relative to a current block position, but are encoded as prediction “modes”, a set of which is shown in FIG. 15. Note that the so-called DC mode represents a simple arithmetic mean of the surrounding upper and left-hand samples.

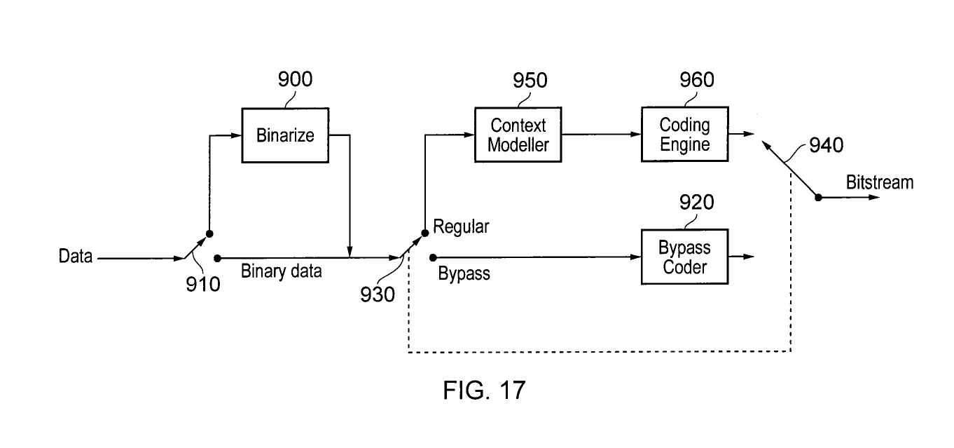

FIG. 16 schematically illustrates a zigzag scan, being a scan pattern which may be applied by the scan unit 360. In FIG. 16, the pattern is shown for an example block of 8×8 DCT coefficients, with the DC coefficient being positioned at the top left position 840 of the block, and increasing horizontal and vertical spatial frequencies being represented by coefficients at increasing distances downwards and to the right of the top-left position 840.

Note that in some embodiments, the coefficients may be scanned in a reverse order (bottom right to top left using the ordering notation of FIG. 16). Also it should be noted that in some embodiments, the scan may pass from left to right across a few (for example between one and three) uppermost horizontal rows, before carrying out a zig-zag of the remaining coefficients.

FIG. 17 schematically illustrates the operation of a CABAC entropy encoder.

The CABAC encoder operates in respect of binary data, that is to say, data represented by only the two symbols 0 and 1. The encoder makes use of a so-called context modelling process which selects a “context” or probability model for subsequent data on the basis of previously encoded data. The selection of the context is carried out in a deterministic way so that the same determination, on the basis of previously decoded data, can be performed at the decoder without the need for further data (specifying the context) to be added to the encoded datastream passed to the decoder.

Referring to FIG. 17, input data to be encoded may be passed to a binary converter 900 if it is not already in a binary form; if the data is already in binary form, the converter 900 is bypassed (by a schematic switch 910). In the present embodiments, conversion to a binary form is actually carried out by expressing the quantised DCT coefficient data as a series of binary “maps”, which will be described further below.

The binary data may then be handled by one of two processing paths, a “regular” and a “bypass” path (which are shown schematically as separate paths but which, in embodiments of the invention discussed below, could in fact be implemented by the same processing stages, just using slightly different parameters). The bypass path employs a so-called bypass coder 920 which does not necessarily make use of context modelling in the same form as the regular path. In some examples of CABAC coding, this bypass path can be selected if there is a need for particularly rapid processing of a batch of data, but in the present embodiments two features of so-called “bypass” data are noted: firstly, the bypass data is handled by the CABAC encoder (950, 960), just using a fixed context model representing a 50% probability; and secondly, the bypass data relates to certain categories of data, one particular example being coefficient sign data. Otherwise, the regular path is selected by schematic switches 930, 940. This involves the data being processed by a context modeller 950 followed by a coding engine 960.

The entropy encoder shown in FIG. 17 encodes a block of data (that is, for example, data corresponding to a block of coefficients relating to a block of the residual image) as a single value if the block is formed entirely of zero-valued data. For each block that does not fall into this category, that is to say a block that contains at least some non-zero data, a “significance map” is prepared by the entropy encoder acting as a map generator (though this function could be carried out by, for example, the scan unit). The significance map indicates whether, for each position in a block of data to be encoded, the corresponding coefficient in the block is non-zero. The significance map data, being in binary form, is itself CABAC encoded. The use of the significance map assists with compression because no data needs to be encoded for a coefficient with a magnitude that the significance map indicates to be zero. Also, the significance map can include a special code to indicate the final non-zero coefficient in the block, so that all of the final high frequency/trailing zero coefficients can be omitted from the encoding. The significance map is followed, in the encoded bitstream, by data defining the values of the non-zero coefficients specified by the significance map.

Further levels of map data are also prepared and are CABAC encoded. An example is a map which defines, as a binary value (1=yes, 0=no) whether the coefficient data at a map position which the significance map has indicated to be “non-zero” actually has the value of “one”. Another map specifies whether the coefficient data at a map position which the significance map has indicated to be “non-zero” actually has the value of “two”. A further map indicates, for those map positions where the significance map has indicated that the coefficient data is “non-zero”, whether the data has a value of “greater than two”. Another map indicates, again for data identified as “non-zero”, the sign of the data value (using a predetermined binary notation such as 1 for +, 0 for −, or of course the other way around).

In embodiments of the invention, the significance map and other maps are generated from the quantised DCT coefficients, for example by the scan unit 360, and is subjected to a zigzag scanning process (or a scanning process selected from zigzag, horizontal raster and vertical raster scanning according to the intra-prediction mode) before being subjected to CABAC encoding.

In general terms, CABAC encoding involves predicting a context, or a probability model, for a next bit to be encoded, based upon other previously encoded data and/or data elements having nearby positions, in an array of data elements, to that of the current data element. If the next bit is the same as the bit identified as “most likely” by the probability model, then the encoding of the information that “the next bit agrees with the probability model” can be encoded with great efficiency. It is less efficient to encode that “the next bit does not agree with the probability model”, so the derivation of the context data is important to good operation of the encoder. The term “adaptive” means that the context or probability models are adapted, or varied during encoding, in an attempt to provide a good match to the (as yet uncoded) next data.

Using a simple analogy, in the written English language, the letter “U” is relatively uncommon. But in a letter position immediately after the letter “Q”, it is very common indeed. So, a probability model might set the probability of a “U” as a very low value, but if the current letter is a “Q”, the probability model for a “U” as the next letter could be set to a very high probability value.

CABAC encoding is used, in the present arrangements, for at least the significance map and the maps indicating whether the non-zero values are one or two. Bypass processing—which in these embodiments is identical to CABAC encoding but for the fact that the probability model is fixed at an equal (0.5:0.5) probability distribution of 1s and 0s, is used for at least the sign data and the map indicating whether a value is >2. For those data positions identified as >2, a separate so-called escape data encoding can be used to encode the actual value of the data. This may include a Golomb-Rice encoding technique.

Accordingly, the CABAC process and the CAVLC process as applied to the data under discussion here are examples of a video data encoding technique (as implemented in the present embodiments by the apparatus to be described), in which arrays of frequency domain video data, reordered for encoding (by, for example, the scanning process described in this description), are encoded using encoding parameters (for example, a context variable) in respect of a current array element which are derived from previously encoded array elements and/or array elements having nearby positions, in the array of video data, to that of the current array element.

The CABAC context modelling and encoding process is described in more detail in WD4: Working Draft 4 of High-Efficiency Video Coding, JCTVC-F803_d5, Draft ISO/IEC 23008-HEVC; 201x(E) 2011-10-28.

FIG. 18 schematically illustrates a CAVLC entropy encoding process.

As with CABAC discussed above, the entropy encoding process shown in FIG. 18 follows the operation of the scan unit 360. It has been noted that the non-zero coefficients in the transformed and scanned residual data are often sequences of ±1. The CAVLC coder indicates the number of high-frequency ±1 coefficients by a variable referred to as “trailing 1s” (T1s). For these non-zero coefficients, the coding efficiency is improved by using different (context-adaptive) variable length coding tables.

Referring to FIG. 18, a first step 1000 generates values “coeff_token” to encode both the total number of non-zero coefficients and the number of trailing ones. At a step 1010, the sign bit of each trailing one is encoded in a reverse scanning order. Each remaining non-zero coefficient is encoded as a “level” variable at a step 1020, thus defining the sign and magnitude of those coefficients. At a step 1030 a variable total_zeros is used to code the total number of zeros preceding the last nonzero coefficient. Finally, at a step 1040, a variable run_before is used to code the number of successive zeros preceding each non-zero coefficient in a reverse scanning order. The collected output of the variables defined above forms the encoded data.

In CAVLC, data elements are encoded according to a “context” which may be derived from previously encoded data elements and/or spatially nearby data elements (or data elements nearby, in an array of data elements).

As mentioned above, a default scanning order for the scanning operation carried out by the scan unit 360 is a zigzag scan is illustrated schematically in FIG. 16. In other arrangements, four blocks where intra-image encoding is used, a choice may be made between zigzag scanning, a horizontal raster scan and a vertical raster scan depending on the image prediction direction (FIG. 15) and the transform unit (TU) size.

However, in embodiments of the present invention, different scanning orders can be employed. The choice between scanning orders can be made in various different ways, instances of which will be described below. For example, a choice may be made according to the prediction direction (mode) established for intra-coding, as discussed above with reference to the set of modes illustrated in FIG. 15. Another example relates to an arrangement in which the scan order depends upon properties of the motion vectors derived by the motion estimator 550 of FIG. 6. The reason that directional information is relevant is that the different scan orders can give different efficiencies of the subsequent entropy encoding process, in dependence upon the direction or orientation of image features in the blocks to be compressed. In another example, a scanning mode is selected based upon an analysis (for example, by the scan unit) of the properties of the data to be scanned, or upon a trial encoding process of some or all of the relevant image or block of data and a comparison (both carried out, for example, by the scan unit) of the quantities of data which would be produced by each different respective candidate scanning technique, the candidate scanning technique which results in the lowest output data quantity being selected.

In embodiments of the invention, these variations apply to the use of arithmetic coding techniques such as CABAC entropy encoding and to CAVLC entropy encoding.

The following arrangements will be described in the context of an example video data encoding apparatus (such as that described above) in which arrays of video data are reordered for entropy encoding, the apparatus comprising: a frequency domain converter (such as the transform unit 340) for generating a frequency domain representation of data derived from an input video signal, the frequency domain representation comprising an array of plural frequency domain coefficients in respect of each image area (the array elements to be encoded by embodiments of the invention depending on the frequency domain coefficients); a selector (for example, associated with the scan unit 360, an example being discussed below with reference to FIGS. 31-34) for selecting a reordering pattern from a set of two or more candidate reordering patterns, for use in reordering the array of frequency domain coefficients; a data scanner (such as the scan unit 360) for changing the order of the frequency domain coefficients according to the selected reordering pattern so as to generate reordered coefficients; and an entropy encoder (such as the encoder 370) for entropy-encoding the reordered coefficients. In embodiments of the invention, a quantiser (such as the quantiser 350) is provided for quantising the frequency domain coefficients before the coefficients are reordered by the data scanner. In embodiments of the invention a map generator is provided (for example, as part of the functionality of the scan unit 360 and/or the entropy encoder 370) for generating binary data indicative of positions, within an array of the frequency domain coefficients, of coefficients of particular respective values or ranges of values. As mentioned above, the techniques are particularly applicable to the encoding of residual data, which can tend to have lower image energy and therefore be more suitable for entropy encoding. To this end, embodiments of the invention, as described above, comprise an image predictor (such as the predictor 320) for generating a predicted version of a current image of an input video signal; and a combiner (such as the adder 310) for combining the current image with the predicted version of that image so as to generate a residual image; the frequency domain converter being configured to generate a frequency domain representation of the residual image.

Correspondingly, the techniques may be applied to a data decompression apparatus and method. As discussed above, the inverse scanning and entropy decoding techniques are complementary to the scanning and encoding techniques. The same scan pattern needs to be selected as that used in the encoding side, either on the basis of data (such as a data flag) associated with or forming part of the video signal to be decoded, or on the basis of other encoding parameter data such as the encoding direction (which is also flagged within the video signal to be decoded). Frequency conversion at the decoder is complementary to that carried out at the encoder.

In embodiments of the invention the candidate reordering patterns may include at least one reordering pattern selected from the set consisting of the first reordering pattern, the second reordering pattern and the third reordering pattern described in the present description.

FIGS. 19-20 schematically illustrate a vertical first concave scan order and a horizontal first concave scan order respectively. These are examples of a first reordering pattern arranged to reorder the frequency domain data so that the reordered data comprises successive subsets of the frequency domain data, each subset comprising data representative of a constant spatial frequency in one dimension, the one dimension being different from subset to subset. As normal, a notation is used in which the DC coefficient is represented as the top left corner of the arrays of coefficients 1100 shown in the drawings, and horizontal and vertical spatial frequencies represented by the coefficients increase towards the right and lower regions respectively. In the concave scan orders, all of the coefficients in one row or one column (which have not yet been scanned) are successively scanned as a subset, before moving on to the next column or row in the other direction. The two scanning orders shown in FIGS. 19 and 20 differ according to whether the first column or the first row is dealt with immediately following the scanning of the DC coefficient. So, in FIG. 19, following the DC coefficient, the first column is scanned. Then, all but the DC coefficient of the top row is scanned. A next scan is of all of the first column except for the coefficient on the top row which has already been scanned, and so on. So, at each instance, a vertical column is scanned before a corresponding horizontal row. The pattern builds up in a generally concave fashion. So this is why the order is referred to as a “vertical first” concave scan order. A corresponding discussion would apply to the naming of the horizontal-first concave scan order. Note that all of the examples to be discussed here may be scaled to suit different block sizes as appropriate.

As discussed above, it has been noted that the transforms of residual image data (the difference between an image and a predicted version of the image) often contain frequency content perpendicular to the direction of prediction. A concave scan order of the type shown in FIG. 19 or FIG. 20 can be beneficial because even where the transformed data contains a lot of vertical frequency content, it has been found empirically that the data often has some non-zero coefficients in the top row, representing horizontal frequency content at low or zero vertical frequencies. Similarly, where the transformed data contains a lot of horizontal frequency content, it has been found empirically that the data often has some non-zero coefficients in the first column, representing vertical frequency content at low or zero horizontal frequencies.

Techniques for selecting between the different potential scanning orders will be discussed below.

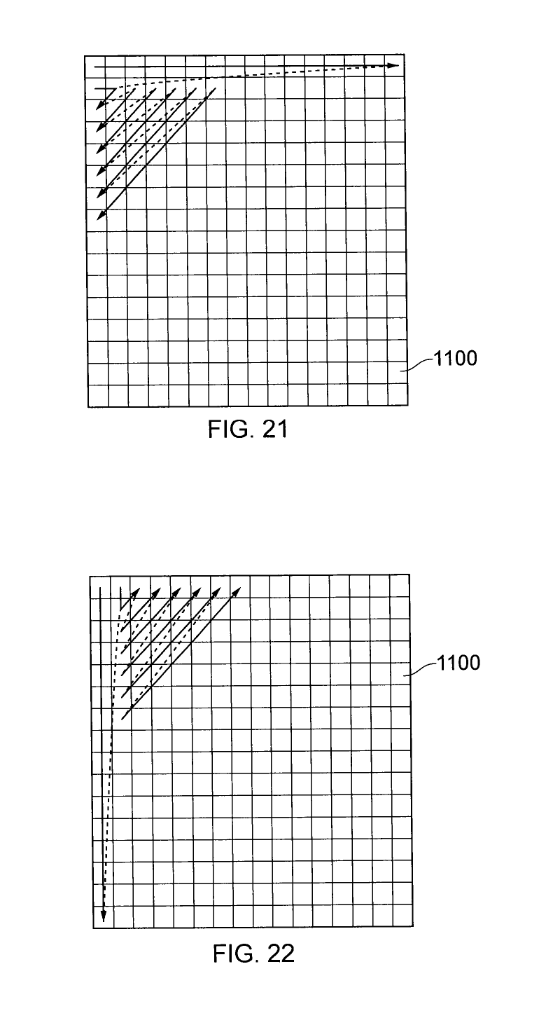

FIG. 21 schematically illustrates a horizontal hybrid zig scanning order and FIG. 22 schematically illustrates a vertical hybrid zig scanning order. These provide examples of a second reordering pattern arranged to reorder the frequency domain data so that data indicative of one or more sets of a constant horizontal spatial frequency or a constant vertical spatial frequency respectively are arranged to precede remaining data of the frequency domain data, the remaining frequency domain data being ordered according to successive subsets, each subset being selected so that the sum of a horizontal spatial frequency component and a vertical spatial frequency component is generally constant for coefficients within a subset.. The “one or more subsets of a constant (horizontal or vertical) spatial frequency” refer to the top scanning row of FIG. 21 (a set of constant vertical spatial frequency) and the left-side vertical column of FIG. 22 (a set of constant horizontal spatial frequency). One such subset (row or column) is illustrated in FIGS. 21 and 22 by way of example, but more than one such subset could be used, for example, a top two or three rows in FIG. 21 or a left-hand two or three columns in FIG. 22. Again, the example patterns shown in the drawings can be scaled according to the required block size. Note that the patterns are referred to here as “zig” scans. This is because the scanning is slightly different from the zig-zag scan of FIG. 16, and in particular does not demonstrate exactly the same backwards-and-forwards diagonal motion as other forms of zig-zag scanning. In other words, the term “zig-zag” scanning is used for scan patterns in which the diagonal scanning motion is first in one diagonal direction, then in the opposite diagonal direction, then in the first diagonal direction, and so on. In the zig patterns of

FIGS. 21 and 22, the diagonal component of the scanning is always (for a particular scan pattern) in the same diagonal direction. But as with FIG. 16, the diagonally scanned subsets in FIGS. 21 and 22 exhibit a generally constant sum of horizontal and vertical frequency component within the subset (that is, along the diagonal scan direction in each case).

The horizontal hybrid zig scanning order of FIG. 21 can be particularly relevant for intra-prediction modes 21, 0 and 22 of FIG. 15, which is to say the intra-prediction modes having a direction closest to vertical, as it includes a first stage of horizontal scanning followed by zig scanning. Similarly, the vertical hybrid zig scanning order of FIG. 22, featuring a first stage of vertical scanning followed by zig scanning, can be particularly relevant for intra-prediction modes 29, 1 and 30, the modes having a prediction direction closest to horizontal.

The hybrid zig scanning orders allow for a complete scan of one lowest-vertical-frequency row or one lowest-horizontal-frequency column of the array of coefficients (or, potentially, an adjacent group of more than one such row or column including the row or column defined above), followed by zig scanning of the remaining coefficients. This is based on the empirical observation that near to a horizontal or vertical intra-prediction direction, there is often noise (non-zero data values, not necessarily representing true image content) in the coefficients perpendicular to the prediction direction. Therefore, to gather together all of these noise-based coefficients, a scan of the row or column perpendicular to the intra-prediction direction can be advantageous and lead to a more efficient entropy encoding process.

It has also been noted empirically that similar trends can be observed for other intra-prediction directions, but because the noise can be more widely distributed amongst the array of coefficients, the advantages of using hybrid zig scanning are reduced.

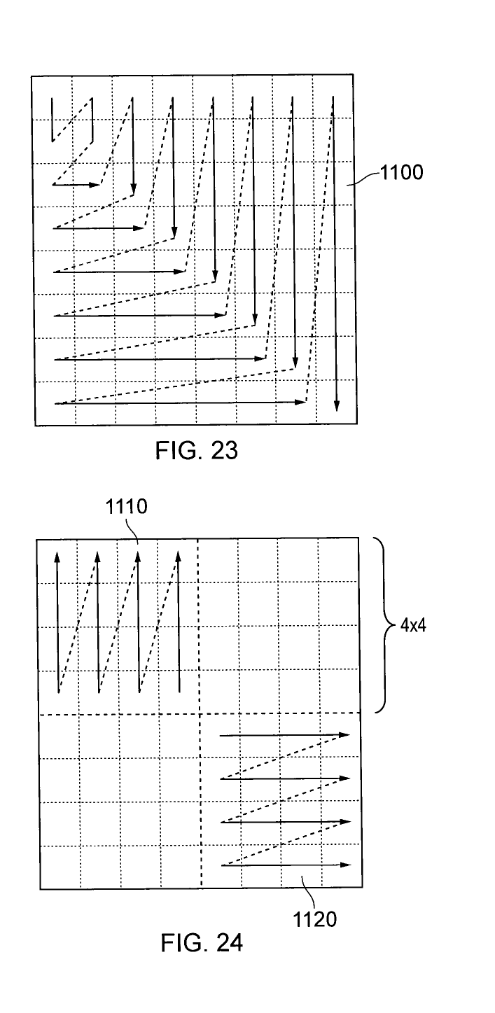

FIG. 23 schematically illustrates a rectangular scan order as an example of a third reordering pattern arranged to reorder the frequency domain data according to successive subsets alternating between a constant and increasing horizontal spatial frequency and a constant and increasing vertical spatial frequency. This scan order is particularly suitable for selection in respect of intra-prediction mode 3, and possibly the immediately adjacent directions (FIG. 15). In mode 3, the prediction direction is at 45° to the horizontal, and as a result the distribution of coefficients in a block (for example, of the significance map) generated in this mode is generally oriented along a diagonal from top left to bottom right of the array of coefficients. One approach might be to provide a scan along the diagonal direction, but this could cause difficulties at the decoding side where it is often the case that coefficient samples above and to the left of a current sample being scanned are required for significance map decoding. Therefore, a rectangular scan pattern as shown in FIG. 23 (which can of course be scaled to other block sizes) can provide an advantageous improvement to the entropy encoding in these situations.

FIG. 24 schematically illustrates an example of mode-dependent scanning in respect of 4×4 transform unit blocks in a CABAC encoded system. Here, the scanning mode for only two of the transform unit blocks is shown (for clarity of the diagram), namely a vertical scan for an upper left transform unit block 1110 and a horizontal scan for a lower right transform unit block 1120.

For large block sizes (for example, 64×64 or 32×32), the hybrid zig scan orders discussed above are not considered to be “throughput friendly”, which is to say that they do not necessarily lend themselves to parallel operation. The term “throughput friendly” in fact relates to the use of so-called “speculation” in the decoding process. In basic terms, the decoding of a particular data value (such as a quantised DCT coefficient) can be affected by the decoding of neighbouring data values. For example, in the CABAC system, the context value and assigned code value used as part of the encoding and decoding process can depend on the data values of spatially nearby previously-encoded coefficient data, as well as on the decoding parameters of data which are nearby in a coding order. At the decoding side, if the data are decoded in a serial order identical to the order in which they were encoded, and the decoding of one data item is completed before any related data is needed for the decoding of a next data item, then there is no difficulty with knowing the values of the previously-encoded data in order to generate the required context data for the decoding of a next data item. But if the data values are decoded in parallel, difficulties can arise.

In such a parallel decoding operation, decoding will be handled other than in this simple serial order, and the decoded results of previous encodings may not be available in time to be used as part of a next decoding. Therefore, “speculation” is used to generate a set of possible outcomes of the decoding of a required nearby data value, before the actual data value is decoded, so as to decode a set of options for the decoded value of a current data item. So, the set of options represents the set of possible decodings of the current data value, given the possible (and as yet unknown) outcome of the decoding of the previous data item. When the required nearby data value is eventually decoded, the correct one of the set of options is selected. So, this can be quicker than the simple serial decoding order mentioned above, because by the time the decoded result of the previous encoding is known, all that remains to do in respect of a next decoded item is to select a correct one of the pre-prepared set of options.

But of course, speculation does have penalties, in particular that the greater the level of speculation, that is, the larger the number of linked inter-dependent decoding results which are handled in this way, the greater the number of permutations of possible outcomes. So, a greater level of speculation, particularly in the context of a hardware based system, can bring the penalty that an exponentially increasing number of speculative decoders is required to generate the sets of options.

Accordingly, it is desirable to aim to limit or reduce the need for speculation.

In terms of the dependence of CABAC parameter values such as contexts on spatially neighbouring coefficients, the need for speculation can potentially be reduced by the choice of scanning order, so that the decoding results of the neighbouring coefficients are known in good time before the decoding processes which depend on those results are carried out.

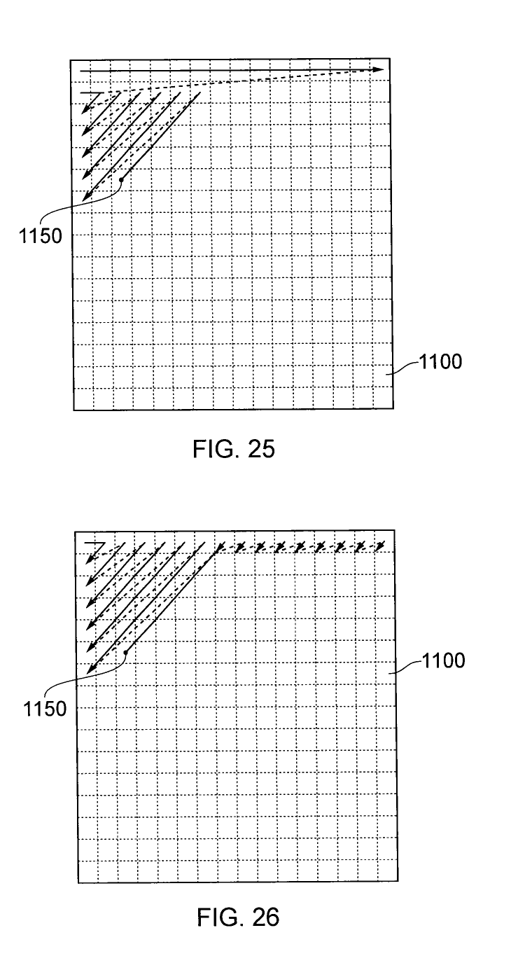

In these instances, and with the aim of reducing speculation and/or increasing encoding efficiency, a zigzag scan order may be considered desirable for encoding the significance map in CABAC systems. However, in embodiments of the invention a hybrid zig scan can be used to detect the position in the array of coefficients of the end of block flag (indicative of a last non-zero data item in the scan order), and then a modified zigzag scan can be used to encode the data values in the significance map as far as the last data item identified by the initial hybrid scan. An example of such an arrangement is shown schematically in FIGS. 25 and 26.

In these embodiments, the end of block (or end of block flag) may be considered as the last non-zero data item in the array, in a scanning order. In the case of the significance map (which indicates zero or non-zero for the coefficients) the end of block is signified simply as the last non-zero entry (the last data item) in the significance map. In the embodiments to be described, the data scanner 360 acts as a last data item detector for searching a current array for a last non-zero array element according to a searching pattern which searches array elements in one or more sets of a constant horizontal spatial frequency or a constant vertical spatial frequency respectively followed by any remaining array elements of the array ordered according to successive subsets, each subset being selected so that the sum of a horizontal spatial frequency component and a vertical spatial frequency component is generally constant for array elements within a subset. It then acts as a data scanner for changing the order of the array elements for entropy encoding according to a reordering pattern so as to generate reordered array elements comprising successive subsets, each subset being selected so that the sum of a horizontal spatial frequency component and a vertical spatial frequency component is generally constant for array elements within a subset, the reordering pattern terminating with the last non-zero array element detected by the last data item detector. The searching operation therefore takes place according to a horizontal scan, a vertical scan, a hybrid horizontal zig scan or a hybrid vertical zig scan. The reordering operation therefore takes place according to a zig scan. The searching and/or reordering patterns can be selected according to the techniques described below for selecting scanning patterns according to image prediction parameters, data parameters and/or trial encodings.

Referring to FIG. 25, the end of block marker in an array of significance map coefficients is shown as a point 1150. As a first stage, a hybrid zig scan (in this example, a horizontal hybrid zig scan, but the choice would depend on the intra-prediction mode) is used (FIG. 25) to locate the end of block marker 1150. Then, the data values are encoded using a zigzag scan until the end of block marker is reached, followed by a scan of the remaining top row coefficients (FIG. 26). Here, if a vertical hybrid zig scan had been selected in dependence upon the intra-prediction mode, then the scan of FIG. 26 would be a zigzag scan followed by a scan of the remaining coefficients in the first column.

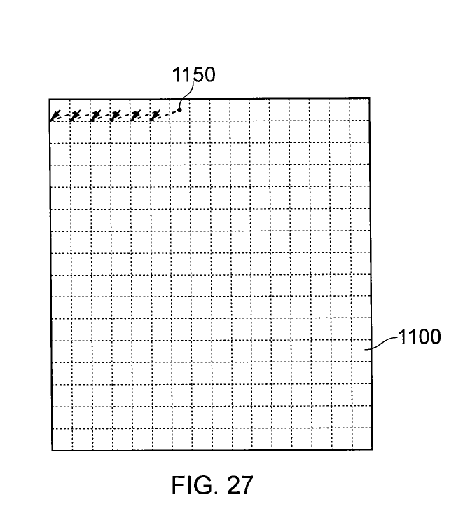

In the special case that the end of block marker is found in the top row, then the scan of FIG. 26 can be substituted for a different scan shown schematically in FIG. 27. Here, there is no need for a zigzag scan and so only the top row as far as the end of block marker 1150 is scanned. In other words, for a case in which the last data item has either a lowest horizontal frequency in the array or a lowest vertical frequency in the array, the data scanner is configured to reorder the array elements as a subset of only the lowest vertical frequency or the lowest horizontal frequency, respectively, in each case in ascending frequency order and terminating at the detected last data item.

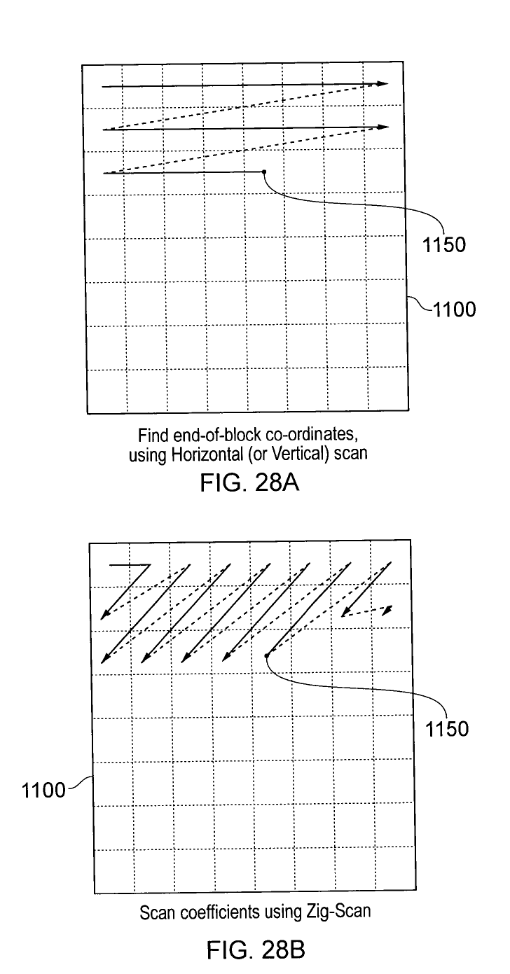

FIGS. 28A and 28B schematically illustrate a throughput-friendly zig scan, as an example whereby the array is scanned using a horizontal (or a vertical) scan to identify the last data item, and then scanned for reordering purposes using a zig scan terminating at the detected last data item.

The arrangements of FIGS. 28A and 28B concern those situations, as described below, when horizontal or vertical scanning is selected for use in respect of a particular block of coefficients. A throughput-friendly approach in these circumstances is to use the selected scanning method (horizontal or vertical raster scanning, as the case may be) to locate the end of block 1150, and then to use a zig-scan to scan the coefficients as far as the end of block. The example shown in FIGS. 28A and 28B (relating to an example 8×8 block, but not limited to this) concerns the situation where a horizontal scan is selected by the scan selection logic for a block; a horizontal raster scan is therefore used to find the end of block position 1150, and the coefficients are scanned using a zig scan in which the diagonal scans start at the top left of the array and are from upper right to lower left directions. If vertical scanning were selected by the scan selection logic, then a vertical raster scan (first column downwards, then second column downwards, and so on) would be used for locating the end of block, followed as before by a zig scan in which diagonal scans start at the top left of the array and proceed in an upper right to lower left direction.

These arrangements have been found to provide a better result with less need for speculation.

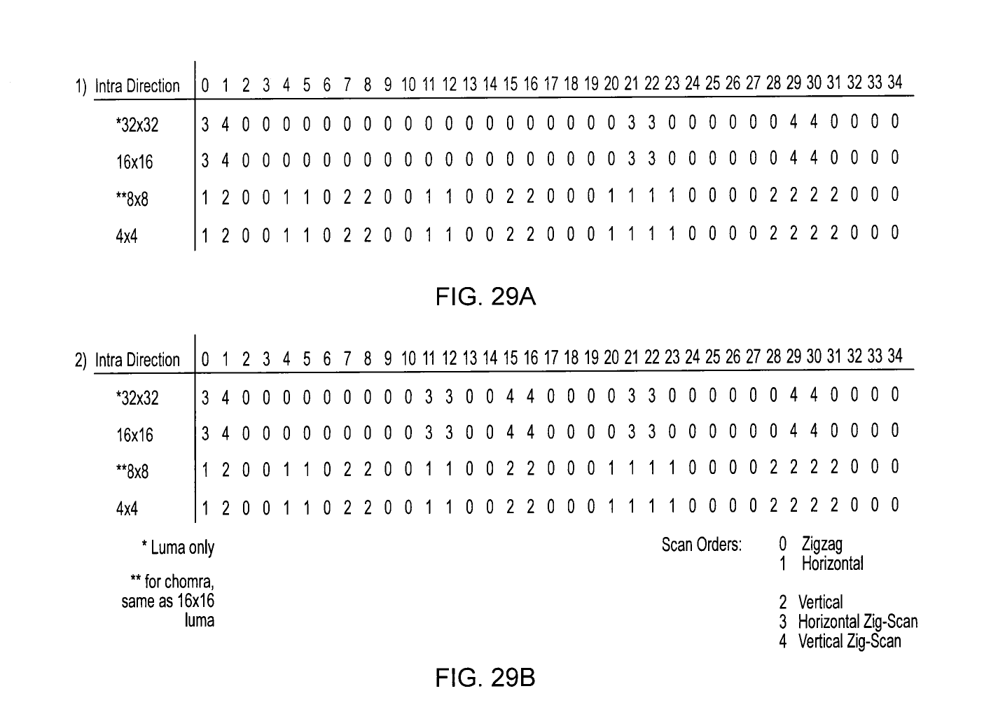

In embodiments of the invention, the dual-stage scan arrangements (identify the last data item, then scan with a zig scan) can be used in place of a zigzag scan in the arrangements defined in FIGS. 29A and 29B, for example.

Various techniques can be used to select the appropriate scan order from a set of two or more candidate scan patterns for use in respect of a block of coefficients. For example, the last data item detector and the data scanner can be configured to select a searching order and/or a reordering pattern in dependence upon one or more parameters used by the image predictor in generating the predicted version of the current image. Such parameters may comprise an image direction representing a prediction direction relating to an intra-image prediction, and/or an image direction representing a motion direction indicative of image motion detected between the current image and another image.

For example, the use of the concave scan orders described above may be selected in dependence upon the detection of a metric in respect of the different candidate scanning orders (for example: horizontal, vertical, horizontal first concave, vertical first concave, zig-zag) that sums the number of occurrences of non-zero coefficients in a particular map to be encoded, weighted by the square of their ‘distance’ (their separation in the order at which they are processed in the candidate scan order). The number of non-zero coefficients is of course the same for a particular block, independent of the scan order, but the weighted sum mentioned above may be different from scan order to scan order. The scan order giving the lowest weighted sum is selected. This effectively penalises (discourages the selection of) scan orders that introduce runs of zeros between significant coefficients.

FIGS. 29A and 29B schematically illustrate selections of scan orders in dependence upon the intra-mode prediction direction associated with an intra-encoded block (that is to say, in dependence upon one or more parameters used by the image predictor in generating the predicted version of the current image). The examples shown in these drawings relates to a choice between five candidate scanning orders, namely a conventional zigzag scan (0), a horizontal raster scan (1), a vertical raster scan (2), a horizontal hybrid zig scan (3) and a vertical hybrid zig scan (4). It will be seen that the horizontal hybrid zig scan tends to be used for intra-prediction directions close to the vertical, and the vertical hybrid zig scan tends to be used for intra-prediction directions close to the horizontal, in both cases in respect of larger block sizes.

However, more generally, the choices can be amongst a set of candidate scan orders including at least one of: a concave scan order, a hybrid zig scan order, and a rectangular scan order, as described above. For example, the hybrid zig scan order (also referred to generically as the second reordering pattern) may be selected for image areas having a predominantly horizontal or vertical image direction (for example, an intra-prediction direction or a motion vector direction), a horizontal hybrid pattern being selected for a predominantly vertical image direction, and vice versa. A concave scan order (also referred to generically as the first reordering pattern) may be selected in respect of a predominantly horizontal or vertical image direction. Here, predominantly horizontal or predominantly vertical could mean, for example, within a predetermined number of (such as one, though other numbers from zero upwards could be used) intra prediction modes (or the equivalent angular range) of horizontal or vertical. The first subset (horizontal first or vertical first) could be selected so that a horizontal first arrangement is used for a predominantly horizontal image direction, and vice versa. A rectangular scan order (also referred to generically as a third reordering pattern) may be selected in respect of a predominantly diagonal image direction. Here, predominantly diagonal could mean, for example, within a predetermined number of (for example, one, though other numbers, from zero upwards could be used) intra prediction modes of a mode at 45 degrees to the horizontal or vertical, or the equivalent angular range.

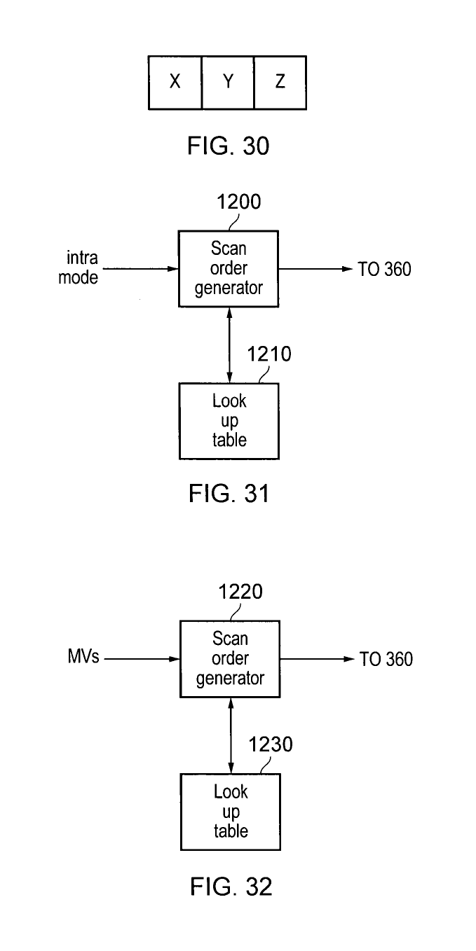

FIG. 30 schematically illustrates a data field or flag defining the scan order or reordering pattern associated with a block. In the example instances discussed above, three data bits (X Y Z) are sufficient to define up to 8 different scanning orders. So, in that example, the overhead associated with the variation of the scanning order would be three data bits per encoded block. An explicit signalling of scan order using this (or another) type of data field associated with the output encoded video signal would be required if the scan order were derived (as mentioned above) from the properties of the block of data to be encoded, because the block would not be available at the decoder for the same analysis to be made, before the scanning process would need to be selected at the decoder. However, if the scanning order is defined as a deterministic function of other data such as the intra-prediction direction or the properties of the motion vectors associated with a block, then the overhead may be as low as zero because the same deterministic derivation can be used at the decoder to establish which scanning order has been used. Here, the expectation is that the candidates scanning orders are defined at both the encoder and the decoder, for example by look up tables held by the scan unit 360.

FIG. 31 schematically illustrates an arrangement for establishing a scanning order in dependence upon the intra-mode prediction direction. The arrangement of FIG. 31 could be part of the scan unit 360 or could be embodied as a separate process or device.

A scan order generator 1200 receives data from the intra-mode selector 520 defining the selected intra-prediction mode for the current block. With reference to a lookup table 1210, the scan order generator 1200 selects a scan order and passes data to the scan unit 360 defining the selected scan order.

FIG. 32 schematically illustrates a similar arrangement for establishing a scanning order in dependence upon properties of the motion vectors used for inter-image prediction and derived in respect of a current block (which again represent an image direction used by the predictor, indicative of image motion between a current image and another image). Here, a scan order generator 1220 receives data representing the current motion vectors from the motion estimator 550, and with reference to a lookup table 1230, generates data defining a scan order to be passed to the scan unit 360.

The derivation of scan order with respect to motion vector direction can be carried out using the same underlying techniques as those described with reference to FIGS. 28 and 29, so that motion vectors indicative of near-vertical or near-horizontal motion (for example, within a threshold angular deviation of vertical or horizontal motion) can cause the scan order generator 1220 to select a hybrid horizontal zigzag scan or a hybrid vertical zigzag scan respectively.

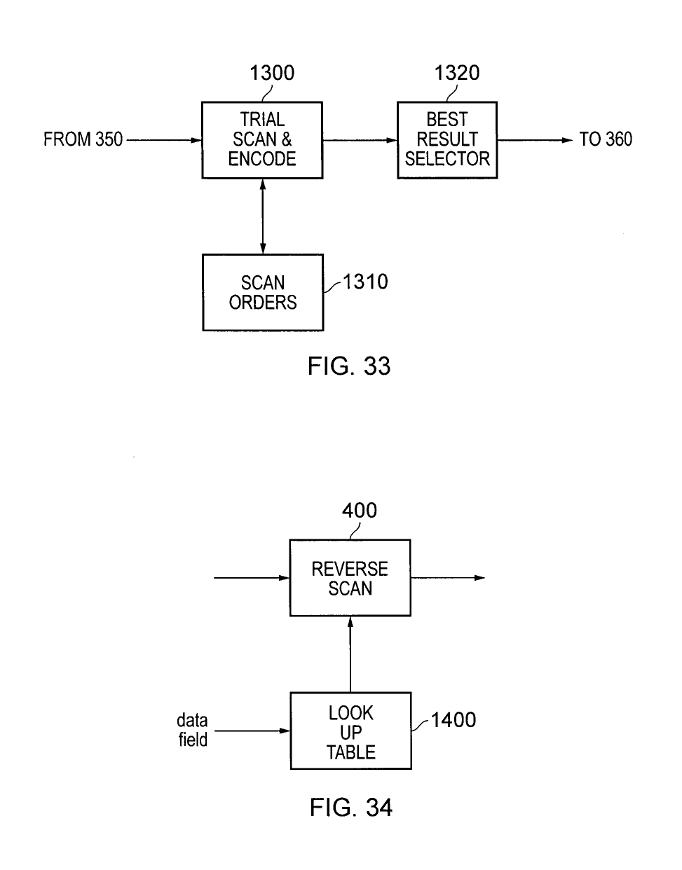

FIG. 33 schematically illustrates a scan order selector based on trial encoding. This arrangement can be used to select amongst any of the various scan orders discussed above. The actual data to be encoded (from the quantiser 350) is passed to a trial scanner and encoder 1300 which carries out multiple scanning and encoding operations on the basis of candidate scan orders stored in a scan order memory 1310. A best result selector 1320 selects the most appropriate scan order on the basis of the lowest number of output data bits generated using that scan order.

It will be appreciated that it is not necessarily the case that all scan orders have to be tested using the arrangement of FIG. 33; rules can be established that exclude certain scan orders, for example a vertical hybrid zigzag scan can be excluded from testing where the intra-prediction direction or the predominant motion vectors are in a vertical direction. Alternatively, an exhaustive test can be carried out. Because the selection of a scan order by the arrangement of FIG. 33 is not based upon a deterministic relationship with an intra-prediction direction or motion vector properties, a data field similar to that shown in FIG. 30 is required to transmit data defining the selected scan order to the decoder.

Finally, FIG. 34 schematically illustrates the selection of a scan order at the decoder. A look-up table 1400 receives as an input either the data field of FIG. 30 or, in a case where the scan order is deterministically derived at encoder and decoder, the source data (such as intra-prediction direction) from which the deterministic decision is made. The look-up table contains details of the various scan orders and supplies data defining the scanning pattern to the reverse scan unit 400. The candidate reverse scanning patterns are the respective inverses of the scanning patterns described above.

Thus, the foregoing discussion discloses and describes merely exemplary embodiments of the present invention. As will be understood by those skilled in the art, the present invention may be embodied in other specific forms without departing from the spirit or essential characteristics thereof. Accordingly, the disclosure of the present invention is intended to be illustrative, but not limiting of the scope of the invention, as well as other claims. The disclosure, including any readily discernible variants of the teachings herein, defines, in part, the scope of the foregoing claim terminology such that no inventive subject matter is dedicated to the public.

1. Video data encoding apparatus in which arrays of video data are reordered for entropy encoding, the apparatus comprising:
a frequency domain converter for generating a frequency domain representation of data derived from an input video signal, the frequency domain representation comprising an array of plural frequency domain coefficients in respect of each image area;
a selector for selecting a reordering pattern from a set of two or more candidate reordering patterns, for use in reordering the array of frequency domain coefficients;
a data scanner for changing the order of the frequency domain coefficients according to the selected reordering pattern so as to generate reordered coefficients; and
an entropy encoder for entropy-encoding the reordered coefficients;
in which the candidate reordering patterns include at least one reordering pattern selected from the list consisting of:
a first reordering pattern arranged to reorder the frequency domain data so that the reordered data comprises successive subsets of the frequency domain data, each subset comprising data representative of a constant spatial frequency in one dimension, the one dimension being different from subset to subset;
a second reordering pattern arranged to reorder the frequency domain data so that data indicative of one or more sets of a constant horizontal spatial frequency or a constant vertical spatial frequency respectively are arranged to precede remaining data of the frequency domain data, the remaining frequency domain data being ordered according to successive subsets, each subset being selected so that the sum of a horizontal spatial frequency component and a vertical spatial frequency component is generally constant for coefficients within a subset; and
a third reordering pattern arranged to reorder the frequency domain data according to successive subsets alternating between a constant and increasing horizontal spatial frequency and a constant and increasing vertical spatial frequency.

2. Apparatus according to claim 1, comprising a quantiser for quantising the frequency domain coefficients before the coefficients are reordered by the data scanner.

3. Apparatus according to claim 2, comprising a map generator for generating binary data indicative of positions, within an array of the frequency domain coefficients, of coefficients of particular respective values or ranges of values.

4. Apparatus according to claim 1, comprising:
an image predictor for generating a predicted version of a current image of an input video signal; and
a combiner for combining the current image with the predicted version of that image so as to generate a residual image;
the frequency domain converter being configured to generate a frequency domain representation of the residual image.

5. Apparatus according to claim 4, in which the selector is configured to select a reordering pattern in dependence upon one or more parameters used by the image predictor in generating the predicted version of the current image.

6. Apparatus according to claim 5, in which the one or more parameters comprises an image direction representing a prediction direction relating to an intra-image prediction.

7. Apparatus according to claim 5, in which the one or more parameters comprises an image direction representing a motion direction indicative of image motion detected between the current image and another image.

8. Apparatus according to claim 6, in which the selector is configured to select the second reordering pattern by which data indicative of a constant horizontal spatial frequency are arranged to precede all other data of the frequency domain data in respect of an image area having at least a predominantly vertical image direction, and to select the second reordering pattern by which data indicative of a constant vertical spatial frequency are arranged to precede all other data of the frequency domain data in respect of an image area having at least a predominantly horizontal image direction.

9. Apparatus according to claim 6, in which the selector is configured to select the first reordering pattern in respect of an image area having at least a predominantly horizontal or a predominantly vertical image direction.

10. Apparatus according to claim 9, in which the first reordering pattern is applied so that the first of the subsets has a constant spatial frequency in a dimension corresponding to the predominant image direction.

11. Apparatus according to claim 6, in which the selector is configured to select the third reordering pattern for an image area having a predominantly diagonal image direction.

12. Apparatus according to claim 1, in which the selector is configured to carry out one or more trial entropy encodings using different respective candidate reordering patterns, and to select a reordering pattern which the trial encoding indicates will give the lowest output data quantity.

13. Apparatus according to claim 1, comprising a data flag generator for generating data, to be associated with the encoded output video signal, indicative of which reordering pattern was selected by the selector.

14. Video data decompression apparatus comprising:
an entropy decoder for entropy-decoding an input encoded video signal to generate reordered frequency domain data;
a selector for selecting a reordering pattern from a set of two or more candidate reordering patterns, for use in ordering the reordered frequency domain data;
a data scanner for changing the order of the reordered frequency domain coefficients according to the selected reordering pattern so as to generate ordered frequency domain data;
a frequency domain converter for generating a spatial domain representation of a residual image from the ordered frequency domain data in which the candidate reordering patterns include at least one reordering pattern selected from the list consisting of:
a first reordering pattern arranged to reorder frequency domain data comprising successive subsets of the frequency domain data, each subset comprising data representative of a constant spatial frequency in one dimension, the one dimension being different from subset to subset;
a second reordering pattern arranged to reorder frequency domain data in which data indicative of one or more sets of a constant horizontal spatial frequency or a constant vertical spatial frequency respectively are arranged to precede remaining data of the frequency domain data, the remaining frequency domain data being ordered according to successive subsets, each subset being selected so that the sum of a horizontal spatial frequency component and a vertical spatial frequency component is generally constant for coefficients within a subset; and
a third reordering pattern arranged to reorder frequency domain data comprising successive subsets alternating between a constant and increasing horizontal spatial frequency and a constant and increasing vertical spatial frequency.

15. Apparatus according to claim 14, in which the selector is configured to select a reordering pattern in dependence upon data forming part of the compressed video signal.

16. Apparatus according to claim 15, in which the selector is configured to select a reordering pattern in dependence upon data associated with the compressed video signal, specifying a reordering pattern.

17. Apparatus according to claim 15, in which the selector is configured to select a reordering pattern in dependence upon data specifying parameters to be applied by the image predictor in generating the predicted version of the current image to be decompressed.

18. A video data compression method in which arrays of video data are reordered for entropy encoding, the method comprising the steps of:
generating a frequency domain representation of data derived from an input video signal, the frequency domain representation comprising an array of plural frequency domain coefficients in respect of each image area;
selecting a reordering pattern from a set of two or more candidate reordering patterns, for use in reordering the array of frequency domain coefficients;
changing the order of the frequency domain coefficients according to the selected reordering pattern so as to generate reordered coefficients; and
entropy-encoding the reordered coefficients;
in which the candidate reordering patterns include at least one reordering pattern selected from the list consisting of:
a first reordering pattern arranged to reorder the frequency domain data so that the reordered data comprises successive subsets of the frequency domain data, each subset comprising data representative of a constant spatial frequency in one dimension, the one dimension being different from subset to subset;
a second reordering pattern arranged to reorder the frequency domain data so that data indicative of one or more sets of a constant horizontal spatial frequency or a constant vertical spatial frequency respectively are arranged to precede remaining data of the frequency domain data, the remaining frequency domain data being ordered according to successive subsets, each subset being selected so that the sum of a horizontal spatial frequency component and a vertical spatial frequency component is generally constant for coefficients within a subset; and
a third reordering pattern arranged to reorder the frequency domain data according to successive subsets alternating between a constant and increasing horizontal spatial frequency and a constant and increasing vertical spatial frequency.

19. Video data encoded by the encoding method of claim 18.

20. A data carrier storing video data according to claim 19.

21. A video data decompression method comprising the steps of:
entropy-decoding an input encoded video signal to generate reordered frequency domain data;
selecting a reordering pattern from a set of two or more candidate reordering patterns, for use in ordering the reordered frequency domain data;
changing the order of the reordered frequency domain coefficients according to the selected reordering pattern so as to generate ordered frequency domain data;
generating a spatial domain representation of a residual image from the ordered frequency domain data in which the candidate reordering patterns include at least one reordering pattern selected from the list consisting of:
a first reordering pattern arranged to reorder frequency domain data comprising successive subsets of the frequency domain data, each subset comprising data representative of a constant spatial frequency in one dimension, the one dimension being different from subset to subset;
a second reordering pattern arranged to reorder frequency domain data in which data indicative of one or more sets of a constant horizontal spatial frequency or a constant vertical spatial frequency respectively are arranged to precede remaining data of the frequency domain data, the remaining frequency domain data being ordered according to successive subsets, each subset being selected so that the sum of a horizontal spatial frequency component and a vertical spatial frequency component is generally constant for coefficients within a subset; and
a third reordering pattern arranged to reorder frequency domain data comprising successive subsets alternating between a constant and increasing horizontal spatial frequency and a constant and increasing vertical spatial frequency.

22. A non-transitory storage medium on which computer software which, when executed by a computer, causes the computer to carry out the method of claim 21 is stored.

23. A non-transitory storage medium on which computer software which, when executed by a computer, causes the computer to carry out the method of claim 18 is stored.

24. Video data capture, transmission and/or storage apparatus comprising apparatus according to claim 1.
